(19) United States
(12) Patent Application Publication
(10) Pub. No.: US 2016/0037089 A1
(43) Pub. Date: Feb. 4, 2016

(54) MULTI-BAND THERMAL IMAGING SENSOR WITH INTEGRATED FILTER ARRAY

(71) Applicant: RAYTHEON COMPANY, Waltham, MA (US)

(72) Inventors: John F. Silny, Playa Vista, CA (US); Hector M. Reyes, JR., Richardson, TX (US)

(21) Appl. No.: 14/446,869

(22) Filed: Jul. 30, 2014

(51) Int. Cl. H04N 5/33

(52) U.S. Cl. CPC H04N 5/332

(57) ABSTRACT

Infrared imaging systems and methods incorporating the use of pixelated filter arrays integrated with the imaging detector. In one example, an infrared imaging system includes imaging optics that focus infrared radiation towards a focal plane of the system, an uncooled focal plane array sensor configured to receive the infrared radiation from the imaging optics, and a processor coupled to the uncooled focal plane array sensor and configured to receive and process image data received from the uncooled focal plane array sensor. The uncooled focal plane array sensor includes a two-dimensional array of microbolometer pixels and a corresponding two-dimensional filter array integrated and aligned with the two-dimensional array of microbolometer pixels such that each microbolometer pixel has a corresponding filter. The filter array is configured to filter the infrared radiation into at least two spectral bands or at least two polarizations.

### BACKGROUND

Thermal or infrared imaging systems are widely used in a variety of commercial and military applications. These systems generally employ focal plane array (FPA) imaging sensors in which either cryogenically cooled materials (e.g., Indium-Antimonide, Mercury-Cadmium-Telluride) or room temperature devices (e.g., microbolometers) are used as detector pixel elements in a two dimensional array. Microbolometers have the advantage of operating at room temperature without the need for and complexity of cryogenic cooling. The two-dimensional focal plane array absorbs and measures incoming infrared radiation from a scene of interest into electrical signals that are applied to a readout integrated circuit (ROIC). After amplification, desired signal shaping and processing, the resulting signals can be further processed as desired to provide an image of the scene of interest.

In many applications it is desirable to capture infrared imagery in multiple spectral bands, for example in the short-wave infrared spectrum (from approximately 1.1 to 3 micrometers), mid-wave infrared spectrum (from approximately 3 to 7 micrometers), and long-wave infrared spectrum (from approximately 7 to 15 micrometers). Commercially available spectrally selective, band-pass filters may be used to “divide up” the incident infrared radiation into the spectral bands of interest. However, using such uncooled commercial filters with typical lower F-number optical systems may pose challenges as the filters only transmit over a certain spectral range (the band-pass), but reflect or emit radiation at all other regions of the spectrum. Therefore, if a band-pass filter is placed in front of an imaging sensor, the image is degraded by parasitic background radiation from both the emission of the filter and the reflection off of the filter. Accordingly, to obtain desired image quality and sensitivity, most conventional multi-spectral infrared imaging systems use cryogenically cooled FPA sensors, along with cooled individual optical band-pass filters or multiple filters in a cooled filter wheel. As a consequence, these systems have increased size, weight, power, and cost (SWAP-C), due to the need for a cooler and to provide thermal rejection paths.

### SUMMARY OF THE INVENTION

Aspects and embodiments are directed to optical systems capable of providing collection of thermal infrared multispectral and/or polarimetric data using an uncooled, low size, weight, power, and cost (SWAP-C) sensor.

According to one embodiment, an infrared imaging system comprises imaging optics configured to receive and focus infrared radiation from a scene towards a focal plane of the infrared imaging system, an uncooled focal plane array sensor configured to receive the infrared radiation from the imaging optics, the uncooled focal plane array sensor including a two-dimensional array of microbolometer pixels and a corresponding two-dimensional filter array integrated and aligned with the two-dimensional array of microbolometer pixels such that each microbolometer pixel has a corresponding filter, the filter array being configured to filter the infrared radiation into at least two spectral bands or at least two polarizations, and a processor coupled to the uncooled focal plane array sensor and configured to receive and process image data received from the uncooled focal plane array sensor.

In one example, the filter array is arranged in a repeating pattern of super-pixels, each super-pixel corresponding to a 2×2 group of the microbolometer pixels. In one example, the filter array includes a polarimetric filter configured such that, for each super-pixel, the array of microbolometer pixels measures irradiance, linear +45° polarization, linear horizontal polarization, and circular polarization. In another example, the filter array is a spectral filter configured to filter the infrared radiation into three spectral bands, including an MWIR band, a first LWIR band, and a second LWIR band. In another example, each super-pixel includes two MWIR filters, one filter for the first LWIR band, and one filter for the second LWIR band. In another example, the filter array is a polarimetric filter configured to filter the infrared radiation into four polarizations, and wherein each super-pixel includes one filter for each of the four polarizations. The four polarizations may include 0°, 30°, 60°, and 90° linear polarizations, for example. In another example, the filter array includes a spectro-polarimetric filter configured to filter the infrared radiation both spectrally and polarimetrically into vertical and horizontal polarization and into the at least two spectral bands.

The infrared imaging system may further comprise an array of microlenses positioned between the imaging optics and the uncooled focal plane array sensor, the array of microlenses being configured to spread each ray of the infrared radiation over at least a 2×2 group of the microbolometer pixels.

In one example, the uncooled focal plane array sensor is disposed away from the focal plane such that the infrared radiation is defocused at the uncooled focal plane array sensor and each ray of the infrared radiation is spread over at least a 2×2 group of the microbolometer pixels.

The infrared imaging system may further comprise a display coupled to the processor, the display being configured to receive processed image data from the processor and to display a representation of the scene based on the processed image data.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1A is a block diagram of one example of a multi-spectral imaging system according to aspects of the present invention;

FIG. 1B is an enlarged view of a portion of the multi-spectral imaging system of FIG. 1;

FIG. 2 is a schematic plan view of one example of a representative portion of multi-spectral focal plane array imaging sensor for use in the imaging system of FIGS. 1A and 1B, according to aspects of the present invention;

FIG. 3 is a graph showing nominal spectral bands based on the spectral radiance as a function of wavelength for a black body at 300 Kelvin;

FIG. 4 is a diagram illustrating an example of a demosaicing approach according to aspects of the invention;

FIG. 5 is a schematic plan view of another example of a representative portion of focal plane array imaging sensor for use in the imaging system of FIGS. 1A and 1B, according to aspects of the present invention;

FIG. 6A is an illustration of a portion of one example of a spectro-polarimetric filter array according to aspects of the present invention;

FIG. 6B is an illustration of a portion of another example of a spectro-polarimetric filter array according to aspects of the present invention;

FIG. 7 is an illustration of a portion of another example of a spectro-polarimetric filter array according to aspects of the present invention;

FIG. 8A is a schematic diagram of a portion of an imaging system implementing one example of a defocusing technique according to aspects of the present invention; and

FIG. 8B is a schematic diagram of a portion of an imaging system including an array of microlenses for intentional defocusing, according to aspects of the present invention.

### DETAILED DESCRIPTION

Aspects and embodiments are directed to a multi-spectral and/or polarimetric infrared imaging system that combines integrated, pixel-level filtering and optical anti-aliasing techniques to provide collection of thermal infrared multispectral and/or polarimetric data using a low size, weight, power, and cost (SWAP-C) sensor. Techniques and systems discussed herein eliminate the need for the cryocooler assembly associated with many conventional thermal multi-spectral imaging systems, and enable sensors for applications where size, weight, power, and cost are significant limiting factors, such as man-portable applications, small unmanned aerial vehicles, commercial medical imaging, and the like. As discussed in more detail below, certain embodiments use mid-wave infrared (MWIR) and long-wave infrared (LWIR) spectral filter and/or polarimetric filters that are integrated into the microbolometer array, unlike conventional multi-spectral systems that use a single or interchangeable filter positioned in front of the detector array. Additionally, certain aspects and embodiments apply intentional defocusing, and/or use a microlens array associated with the microbolometer array, to prevent aliasing, and leverage image reconstruction algorithms previously used for visible-spectrum RGB (red, green, blue) demosaicing to produce high quality thermal infrared image data.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

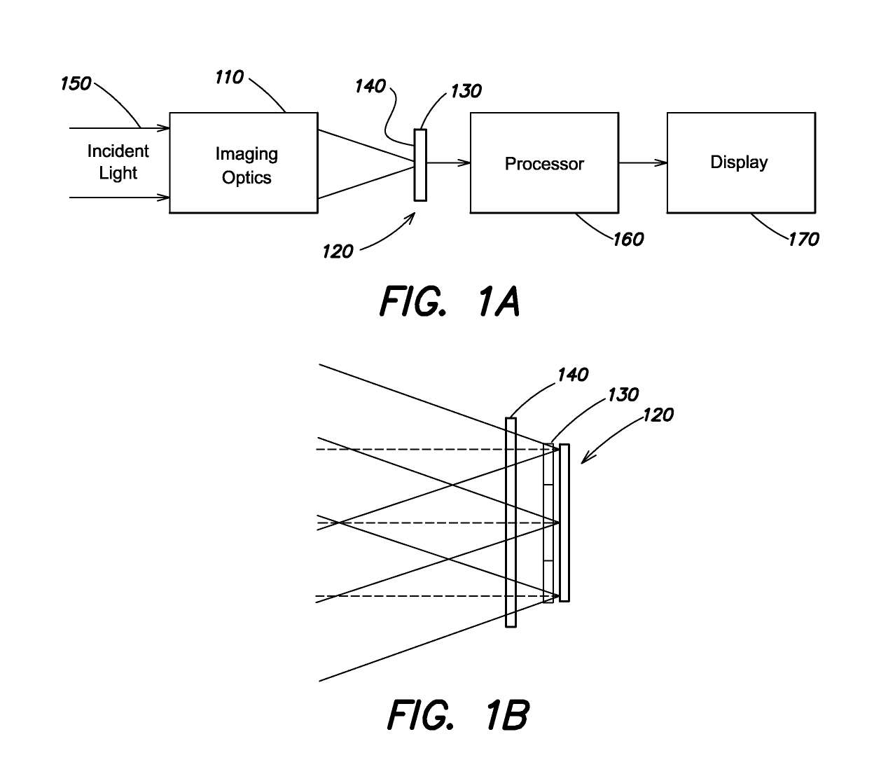

Referring to FIG. 1A, there is illustrated a schematic of one example of an imaging system according to certain embodiments. The system includes ambient (i.e., uncooled) broadband, low F-number (i.e., “fast”) imaging optics 110 and an uncooled microbolometer array 120 with an integrated filter array 130. As discussed in more detail below, the system optionally includes a set of microlenses 140 positioned just in front of the microbolometer array 120. FIG. 1B is an enlarged view of a portion of the system of FIG. 1A, showing the microbolometer array 120, integrated filter array 130, and optional set of microlenses 140.

The imaging optics 110 direct incident electromagnetic radiation 150 radiated from a scene towards microbolometer array 120. The imaging optics 110 may include any of a variety of different types of lenses and/or reflective surfaces (e.g., minors) configured to focus and direct electromagnetic radiation from the scene towards the microbolometer array 120. The optical elements (e.g., minors and/or lenses) making up the imaging optics 110 may include or be made of materials suitable for operation of the system in at least a portion of the infrared spectrum, for example, in the MWIR and/or LWIR spectral bands. In certain examples, the imaging optics 110 have a low F-number, for example, an F-number of about 1. A processor 160 receives image data from the microbolometer array 120, and may perform various image processing functions to produce one or more images of the scene. The image data is then sent to a display 170 to generate an image representing the scene. The display 170 may comprise a dedicated display or a display of a computer, for example. The image may include a portion that represents a target object in the scene. The display 170 may be a “realtime” display that displays false color imagery of the scene to an operator. In certain examples, the display 170 may also display object detections or classifications (e.g., natural vs. man-made) overlaid with the imagery. This information (detections, classifications, etc.) may be computed by the processor 160 and provided to the display 170 with the image data.

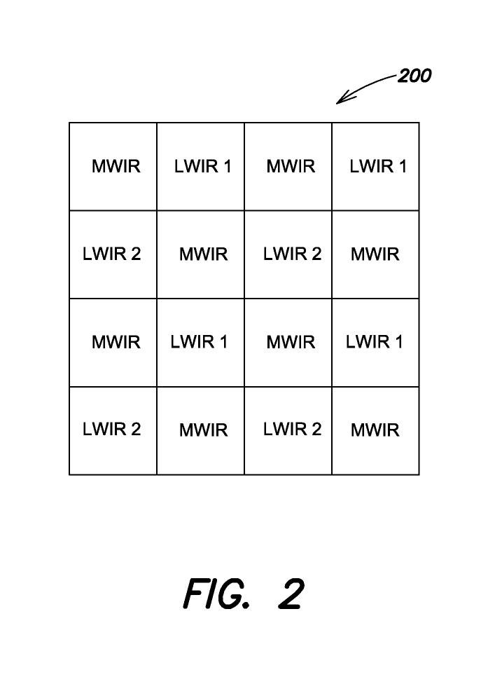

FIG. 2 is an illustration of one example of a sensor 200 including a microbolometer array with an integrated filter array, according to one embodiment. In the illustrated example, a representative 4×4array of pixels is shown; however, in practical implementations, the array may include many thousands or millions of pixels. The integrated filter array is arranged in a pixel-by-pixel pattern aligned with the underlying pixels of the microbolometer array. The pattern may be repeating in blocks of one or more pixels. For example, as shown in FIG. 2, the pattern may repeat over the array in blocks of 2×2 pixels, such that every four pixels form a “super-pixel”. In the example illustrated in FIG. 2, the integrated filter array is a spectral filter array configured for three different spectral bands, namely, the MWIR band, a first portion of the LWIR band (LWIR 1) and a second portion of the LWIR band (LWIR 2). However, as will be appreciated by those skilled in the art, given the benefit of this disclosure, numerous other configurations for the filter array may be implemented, including, but not limited to, other spectral bands, polarization filters, or a combination thereof.

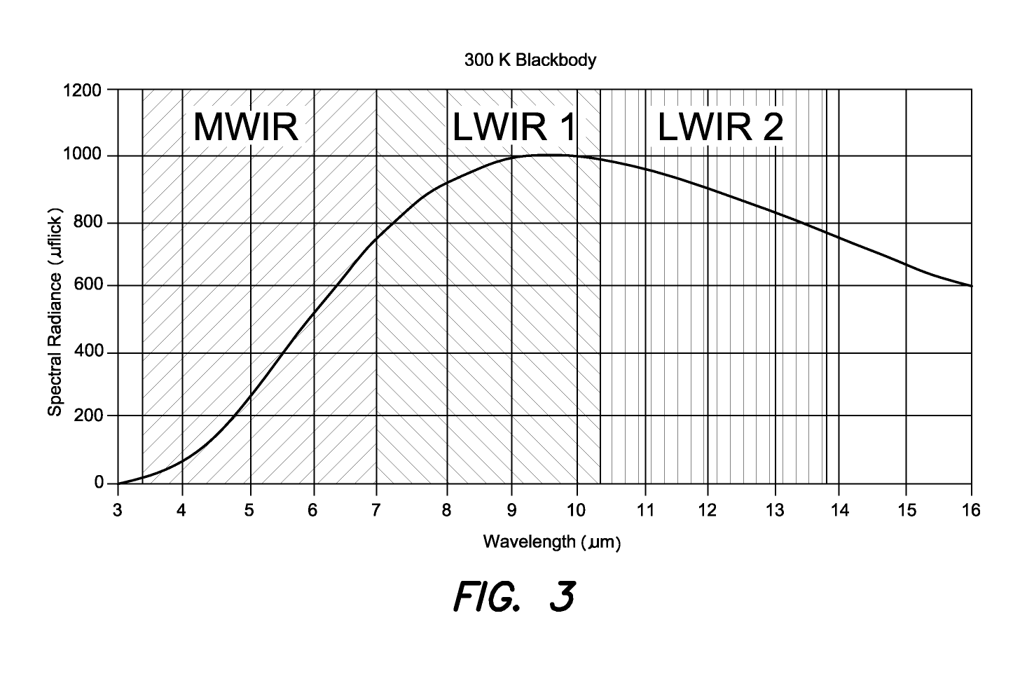

In certain applications, the filter array arrangement illustrated in FIG. 2 may be advantageous in that it allows for simultaneous imaging in the MWIR and LWIR spectral bands with relatively equivalent radiometric collection in both bands. Referring to FIG. 3, the LWIR spectral band covers a wider range of wavelengths than does the MWIR spectral band. Additionally, the thermal radiation from a black body is higher in the LWIR band than in the MWIR band. In order to compensate for the difference in radiation in the spectral bands, this embodiment shows a filter array pattern such as that shown in FIG. 2, where twice as many pixels collect radiation in the MWIR band than in either of the LWIR 1 or LWIR 2 bands, the normalized spectral response (e.g., from a black body) may be more uniform across the two bands, which may simplify the subsequent image processing. The filter pattern illustrated in FIG. 2 bears some resemblance to the well-known Bayer pattern used to filter light in the visible spectral band, but has some important differences. In a four pixel quad, the Bayer pattern uses two pixels for green light (at an intermediate waveband), one for red light (at a long waveband), and one for blue light (at a short waveband), because spectral radiance is highest in the green sub-band, and the human eye is most sensitive to green light. In contrast, the filter pattern shown in FIG. 2 uses two of every four pixels to collect MWIR radiation, the sub-band with the lowest spectral radiance (see FIG. 3) to balance radiometric performance between the MWIR and LWIR bands.

Other embodiments may use other filter arrangements. The microbolometers in the microbolometer array may provide wide (e.g., approximately 2-20 μm) spectral sensitivity. Accordingly, in other embodiments, the filter array 130 may include short-wave infrared (SWIR) and/or multiple MWIR spectral bandpass filters. Such an arrangement may provide an imaging system that is sensitive to both solar reflected and thermal emitted light, for example.

According to one embodiment, standard image reconstruction algorithms may be used to apply “demosaicing” and produce complete images in each of the measured spectral bands. Due to the integrated filter array, each pixel in the sensor 200 measures only one spectral band. Accordingly, each image frame from the array 200 includes a “mosaic” of spatially separated regions corresponding to the different spectral bands that matches the filter array pattern. Referring to FIG. 4, each image frame (i.e., the response from the entire array 200) may be separated into the different spectral bands (represented at 410). The data may then be interpolated (represented at 420) between like pixels measuring like spectral bands to produce, in this case, three independent images 430 (one for each spectral band). Each image 430 is thus produced from measured pixels 210 and interpolated pixels 220. Those skilled in the art will appreciate, given the benefit of this disclosure, that the demosaicing approach may be adapted based on the number of spectral bands for which the filter array 130 is configured to produce a corresponding number of independent images, and is not limited to producing three images. Demosaicing and data interpolation techniques that may be used are well known in the art, for example, such techniques are used in connection with visible imaging systems that incorporate Bayer filters. The demosaicing and data interpolation may be implemented by the processor 160.

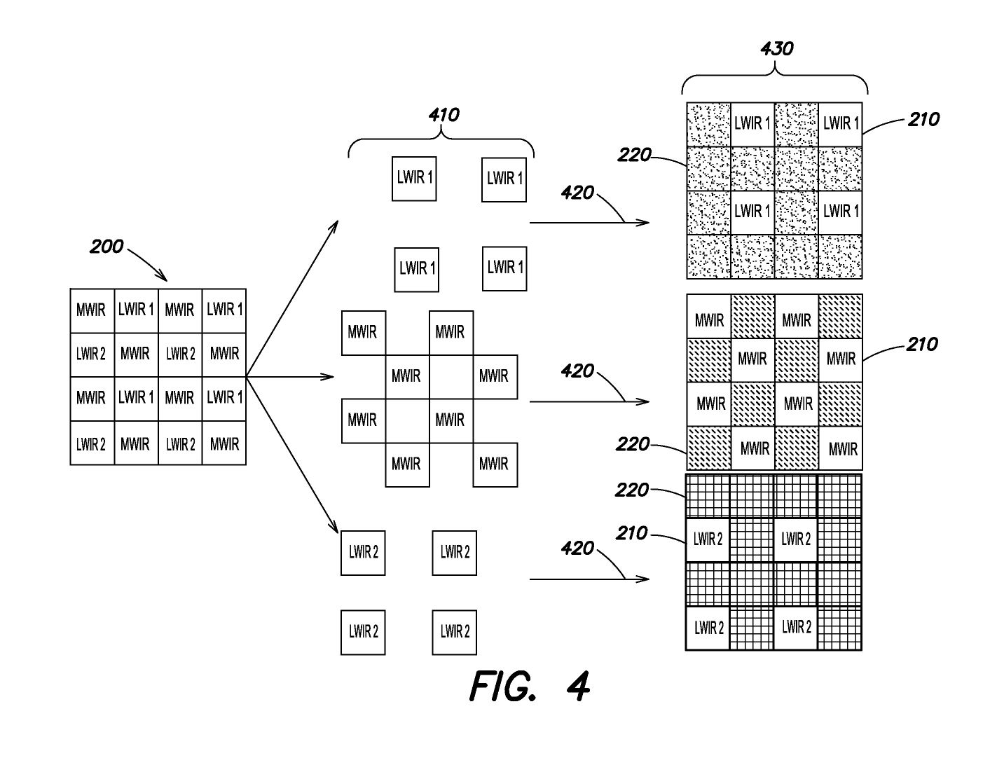

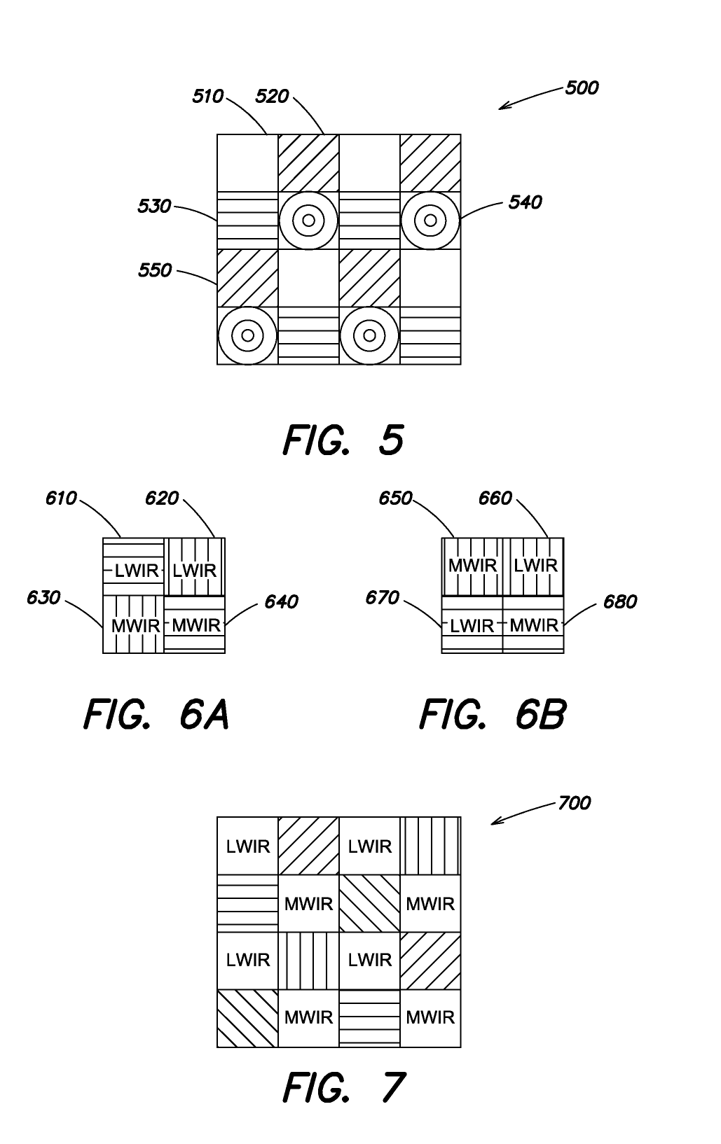

The examples of FIGS. 2-4 discuss spectral filter arrays 130. However, as discussed above, in other examples, the filter array 130 may be a polarization filter array or a spectro-polarimetric filter array (filtering in both polarization and wavelength). FIG. 5 illustrates one example of a polarization filter 500. In this example, the illustrated representative portion of the polarization filter 500 includes a 2×2 grid of super-pixels 550, each super-pixel including a 2×2 array of pixels 510, 520, 530, and 540, each with its own polarization filter. In the illustrated example, pixels 510 measure irradiance (E₀), pixels 520 measure linear +45° polarization (E₂), pixels 530 measure linear horizontal polarization (E₁), and pixels 540 measure circular polarization (E₃). Accordingly, the Stokes vector, S, may be produced from the measurements of each super-pixel 550, according to the equations presented below, which may allow degree of polarization (DOP) and degree of linear polarization (DOLP) to be calculated according to the following equations.

$$\begin{matrix}S = [ \begin{matrix}{\hat{S}}_{0} / {\hat{S}}_{0} \\ {\hat{S}}_{1} / {\hat{S}}_{0} \\ {\hat{S}}_{2} / {\hat{S}}_{0} \\ {\hat{S}}_{3} / {\hat{S}}_{0}\end{matrix} ] = [ \begin{matrix}{S}_{0} \\ {S}_{1} \\ {S}_{2} \\ {S}_{3}\end{matrix} ] \\ In Equation ( 1 ) \text{:} \\ {\hat{S}}_{0} = 2 {E}_{0} \\ {\hat{S}}_{1} = 2 ( {E}_{1} - {E}_{0} ) \\ {\hat{S}}_{2} = 2 ( {E}_{2} - {E}_{0} ) \\ {\hat{S}}_{3} = 2 ( {E}_{3} - {E}_{0} ) & ( 1 ) \\ D O P = \frac{{( {S}_{1}^{2} + {S}_{2}^{2} + {S}_{3}^{2} )}^{1 / 2}}{{S}_{0}} & ( 2 ) \\ D O L P = \frac{{( {S}_{1}^{2} + {S}_{2}^{2} )}^{1 / 2}}{{S}_{0}} & ( 3 )\end{matrix}$$

Other embodiments may use other filter array arrangements. For example, another embodiment, the filter array 130 may include all linear polarization filters, such as a 2×2 super-pixel array (similar to that shown in FIG. 5), where the four filters in each super-pixel include 0°, 30°, 60°, and 90° linear polarizations. The polarization filters may be implemented in a variety of ways, including, for example, wire-grid and/or plasmonic filter manufacturing technologies. Demosaicing techniques, as discussed above, may be applied to separate each image frame into the component polarizations and produce independent images for each polarization.

As discussed above, in other embodiments, the filter array 130 may include a combination of polarimetric filters and spectral filters. For example, referring to FIGS. 6A and 6B, there are illustrated two examples of spectro-polarimetric filters. In FIG. 6A, the spectral filters are arranged in rows (pixels 610 and 620 share one common spectral band, and pixels 630 and 640 share another common spectral band), and the polarimetric filters are arranged in an alternating pixel pattern (pixels 610 and 640 filter horizontal polarization, and pixels 620 and 630 filter vertical polarization). In FIG. 6B, the polarimetric filters are arranged in rows (pixels 650 and 660 filter vertical polarization, and pixels 670 and 680 filter horizontal polarization), and the spectral filters are arranged in an alternating pixel pattern (pixels 650 and 680 filter one spectral band, and pixels 660 and 670 filter another spectral band). Thus, each pixel performs both spectral and polarimetric filtering (e.g., 3-5 μm+vertical polarization). FIG. 7 illustrated another example of a spectro-polarimetric filter array 700 that includes interleaved spectral and polarimetric filters. In the illustrated example, the array 700 is configured to filter two different spectral bands and four linear polarizations (vertical, horizontal, +45 deg, and −45 deg); although a wide variety of other patterns may be used. In this arrangement, each pixel performs either spectral or polarimetric filtering, forming a 4×4 super-pixel. As will be appreciated by those skilled in the art, given the benefit of this disclosure, numerous other spectro-polarimetric filter patterns may be implemented, and the configurations shown in FIGS. 6A, 6B, and 7 are examples only and not intended to be limiting. Demosaicing techniques, as discussed above, may be used to reconstruct images for each spectral band and each polarization.

As discussed above, certain aspects and embodiments apply intentional defocusing, and/or use a microlens array associated with the microbolometer array, to prevent aliasing when interpolating the data between spatially separated pixels. Typically, it is desirable to have the image of a point of light be very tight or focused sharply on the focal plane array, so as to obtain a high resolution image. However, this feature may cause aliasing when demosaicing data from a focal plane array that includes an integrated pixelated filter array 130 according to embodiments discussed herein. For example, if a very small point of MWIR light falls only on a pixel with an LWIR 1 filter, the information contained in that point will be lost and cannot be recovered during the demosaicing process. Accordingly, to avoid aliasing errors during the demosaicing process (that interpolates the data between pixels), it is desirable to have a system with an optical sampling ratio, Q, equal to 2 (representing a system that Nyquist samples the optical information). However, typical microbolometer array systems have Q values of less than or equal to 1, as shown in the examples in Table 1 below. The Q of the system is defined by Equation (4):

$$Q = \frac{λ F / \#}{p} \qquad ( 4 )$$

In Equation (4), λ is the center wavelength in the spectral band of operation, and p is the pixel pitch.

TABLE 1

| | MWIR | LWIR 1 | LWIR 2 |
|---|---|---|---|
| Center wavelength (μm) | 5 | 8 | 12 |
| F-number | 1 | 1 | 1 |
| Pixel pitch (μm) | 12 | 12 | 12 |
| Q | 0.42 | 0.67 | 1.00 |

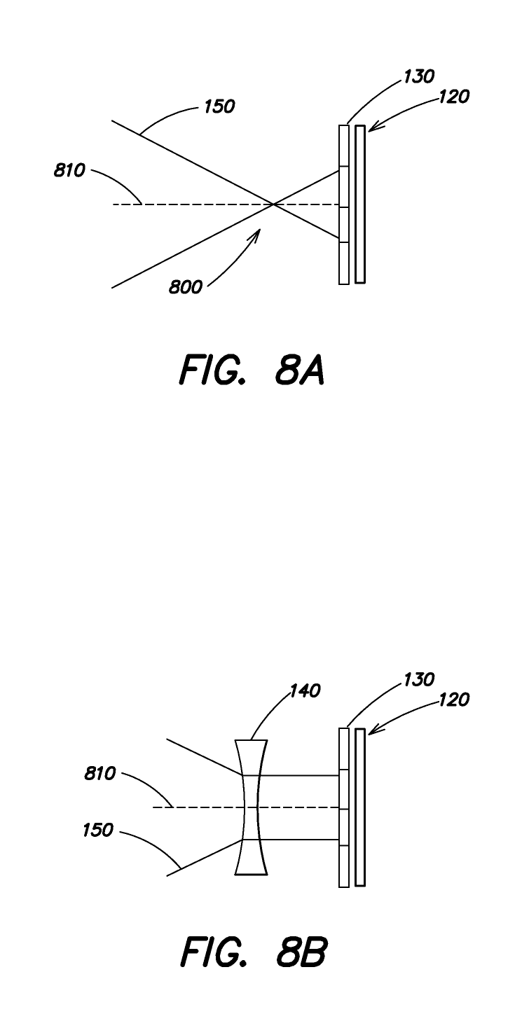

To address this issue and avoid aliasing, embodiments of the imaging system may be configured to intentionally defocus the incoming electromagnetic radiation, so as to spread the radiation over multiple pixels in each array dimension. For example, referring to FIG. 8A, the microbolometer array 120, with the integrated filter array 130, may be positioned slightly away from (e.g., behind or in front of) the focal point 800 of the imaging system along the optical axis 810, such that the incident radiation 150 falls on at least two pixels in each dimension, rather than being focused onto only one pixel. Referring to FIG. 8B, in another embodiment, the imaging system may include an array of microlenses 140, as discussed above. The array of microlenses 140 may similarly spread the incident radiation 150 such that it is received by at least two pixels of the filter array 130 and microbolometer array 120. The position of the microbolometer array 120 and filter array 130, and/or the configuration and position of the microlens array 140, may be selected based at least in part on the filter array pattern so as to substantially avoid aliasing. For example, in systems using a filter array 700 or similar pattern, it may be desirable to spread each ray bundle of the incident radiation (using intentional defocusing, the microlens array 140, or both) over more than two pixels in each array dimension. In general, it is desired to spread the light over the extent of a super-pixel (e.g., 2×2 pixels).

Thus, aspects and embodiments may provide a multi-band imaging system that incorporates an uncooled microbolometer array with an integrated spectral, polarimetric, or spectro-polarimetric filter array to provide a SWAP-C sensor system. As discussed above, various techniques may be used to avoid aliasing that would otherwise result due to the presence of the integrated filter array. Demosaicing techniques and well established image processing algorithms may be used to separate and interpolate the spectral and/or polarimetric data to provide simultaneous multi-band images.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An infrared imaging system comprising:
imaging optics configured to receive and focus infrared radiation from a scene towards a focal plane of the infrared imaging system;
an uncooled focal plane array sensor configured to receive the infrared radiation from the imaging optics, the uncooled focal plane array sensor including a two-dimensional array of microbolometer pixels and a corresponding two-dimensional filter array integrated and aligned with the two-dimensional array of microbolometer pixels such that each microbolometer pixel has a corresponding filter, the filter array being configured to filter the infrared radiation into at least two spectral bands or at least two polarizations; and
a processor coupled to the uncooled focal plane array sensor and configured to receive and process image data received from the uncooled focal plane array sensor.

2. The infrared imaging system of claim 1, wherein the filter array is arranged in a repeating pattern of super-pixels, each super-pixel corresponding to a 2×2 group of the microbolometer pixels.

3. The infrared imaging system of claim 2, wherein the filter array includes a polarimetric filter configured such that, for each super-pixel, the array of microbolometer pixels measures irradiance, linear +45° polarization, linear horizontal polarization, and circular polarization.

4. The infrared imaging system of claim 2, wherein the filter array is a spectral filter configured to filter the infrared radiation into three spectral bands, including an MWIR band, a first LWIR band, and a second LWIR band.

5. The infrared imaging system of claim 4, wherein each super-pixel includes two MWIR filters, one filter for the first LWIR band, and one filter for the second LWIR band.

6. The infrared imaging system of claim 2, wherein the filter array is a polarimetric filter configured to filter the infrared radiation into four polarizations, and wherein each super-pixel includes one filter for each of the four polarizations.

7. The infrared imaging system of claim 6, wherein the four polarizations include 0°, 30°, 60°, and 90° linear polarizations.

8. The infrared imaging system of claim 1, wherein the filter array includes a spectro-polarimetric filter configured to filter the infrared radiation both spectrally and polarimetrically into vertical and horizontal polarization and into the at least two spectral bands.

9. The infrared imaging system of claim 1, further comprising an array of microlenses positioned between the imaging optics and the uncooled focal plane array sensor, the array of microlenses being configured to spread each ray of the infrared radiation over at least a 2×2 group of the microbolometer pixels.

10. The infrared imaging system of claim 1, wherein the uncooled focal plane array sensor is disposed away from the focal plane such that the infrared radiation is defocused at the uncooled focal plane array sensor and each ray of the infrared radiation is spread over at least a 2×2 group of the microbolometer pixels.

11. The infrared imaging system of claim 1, further comprising a display coupled to the processor, the display being configured to receive processed image data from the processor and to display a representation of the scene based on the processed image data.
